(19) United States
(12) Patent Application Publication
(10) Pub. No.: US 2022/0197359 A1
(43) Pub. Date: Jun. 23, 2022

(54) POWER SYNCHRONIZATIONS BETWEEN HOST DEVICES AND DISPLAY DEVICES

(71) Applicant: Hewlett-Packard Development Company, L.P., Spring, TX (US)

(72) Inventors: Shaheen Saroor, Spring, TX (US); Nam Hoang Nguyen, Spring, TX (US); Ted T. Nguy, Spring, TX (US)

(73) Assignee: Hewlett-Packard Development Company, L.P., Spring, TX (US)

(21) Appl. No.: 17/606,087

(22) PCT Filed: Jul. 30, 2019
(86) PCT No.: PCT/US2019/044236

§ 371 Date: Oct. 25, 2021

(51) Int. Cl. G06F 1/26; G06F 1/18; G06F 13/40; G06F 13/38

(52) U.S. Cl. CPC G06F 1/266; G06F 13/382; G06F 13/4068; G06F 1/18

(57) ABSTRACT

An example display device includes a universal serial bus interface to couple to a host computing device; and a power delivery controller interconnected with the universal serial bus interface. The power delivery controller is to obtain from a host state register stored at the display device, a current power state of the host computing device responsive to a change in state of the display device from a first power state to a second power state. The power delivery controller is further to send a power delivery protocol message to the host computing device to synchronize a power state of the host computing device to an updated power state corresponding to the second power state when the current power state of the host computing device corresponds to the first power state. The power delivery controller is further to update the host state register to reflect the updated power state.

### BACKGROUND

Computing devices may include power buttons to change the power state of the computing devices. Computing devices may also be connected to display devices, which have their own power buttons to change the power state of the display devices independently of the computing devices.

### BRIEF DESCRIPTION OF THE DRAWINGS

FIG. 1 is a block diagram of an example display device and host computing device for power synchronization.

FIG. 2 is a block diagram of another example display device and host computing device for power synchronization.

FIG. 3 is a flowchart of a method of power synchronization at a display device in response to a power button actuation at the display device.

FIG. 4 is a flowchart of a method of power synchronization at a display device in response to a power button actuation at a host computing device.

FIG. 5 is a flowchart of a method of power synchronization at a host computing device.

### DETAILED DESCRIPTION

Computing devices, such as personal computers, laptops, desktops, or other types of computing devices such as imaging devices and the like, may be connected to display devices. Each of the computing devices and display devices may include their own power buttons to change the power state of the respective devices independently of each other, A user therefore actuates the power buttons on both the computing device and the display device prior to use.

In some systems, the computing device and the display device may communicate system events to activate profile settings corresponding to the system event. In other systems, an external source may send a message indicating its power status to a computing device, which may change its power status to match the power status of the external source, In these examples, the matching is performed at the destination device (i.e. the device receiving the data pertaining to power status or system events).

In an example system, a host computing device and a display device are connected via a universal serial bus interface. In particular, the universal serial bus interface is capable of supporting power delivery protocols (e.g. type C universal serial bus interfaces). A host state register storing a current power state of the host computing device is stored at the display device for synchronization. When the power button on the display device is actuated, the display device checks the current power state of the host computing device and communicates a power delivery protocol message to the host computing device when changing the power state of the display device would bring the host computing device and the display device out of synchronization. Thus, actuating the power button on the display device changes the power states of both the display device and the host computing device in synchronization, or it changes the power state of the display device to synchronize it with the power state of the host computing device. When the power button on the host computing is actuated, a power delivery protocol message including the updated power state of the host computing device is communicated to the display device. The display device updates the host state register with the updated power state of the host computing device and synchronizes its power state with the updated power state.

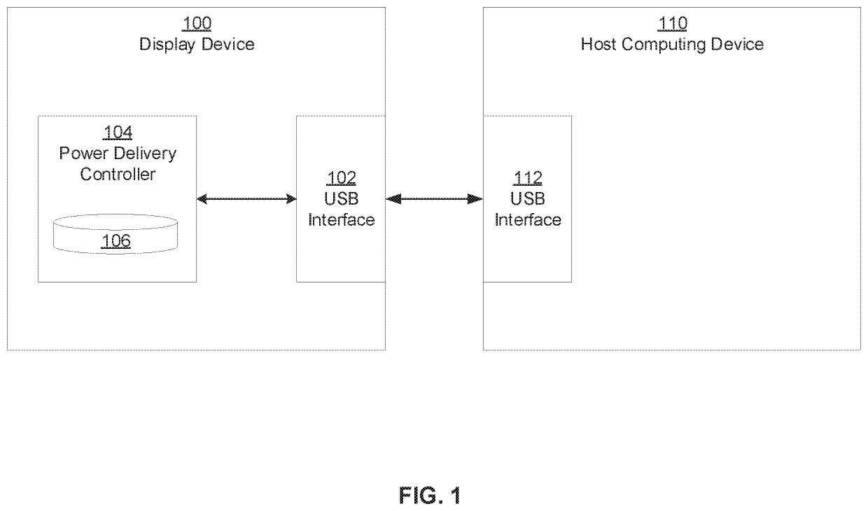

FIG. 1 shows a block diagram of an example display device 100. The display device 100 includes a universal serial bus (USB) interface 102, a power delivery (PD) controller 104 interconnected with the USB interface 102.

The USB interface 102 is to couple to a host computing device 110 via a corresponding USB interface 112 of the host computing device 110. The host computing device 110 may be, for example, a laptop or a notebook computer. In particular, the USB interfaces 102 and 112 may be type C USB interfaces, thus allowing power delivery protocols to be communicated between the display device 100 and the host computing device 110. Further, the type C USB interfaces 102 and 112 may allow vendor defined messages to be communicated between the display device 100 and the host computing device 110.

The PD controller 104 is interconnected with the USB interface 102. The PD controller 104 may include a central processing unit (CPU), a microcontroller, a microprocessor, a processing core, or similar device capable of executing instructions. The PD controller 104 may also include a non-transitory machine-readable storage medium that may be electronic, magnetic, optical, or other physical storage device that stores executable instructions. The PD controller 104 may also store a host state register 106 to record a current power state of the host computing device 110.

In particular, the instructions cause the PD controller 104 to, responsive to a change in state of the display device 100 from a first power state to a second power state, obtain the current power state of the host computing device 110 from the host state register 106. When the current power state of the host computing device corresponds to the first power state, the PD controller 104 sends a power delivery protocol message to the host computing device 110 via the USB interface 102. In particular, the PD protocol message is to synchronize a power state of the host computing device 110 to an updated power state corresponding to the second power state of the display device 100. The host computing device 110 may include a corresponding PD controller (not shown) to synchronize the power state of the host computing device 110 to the updated power state. The PD controller 104 of the display device 100 then updates the host state register 106 to reflect the updated power state.

For example, responsive to a change in state of the display device 100 from a power on state (first power state) to a power off state (second power state), the PD controller 104 obtains the current power state of the host computing device 110 from the host state register 106. If the current power state of the host computing device 110 is, for example, fully functional (S0), then the power states of the display device 100 is determined to correspond with the first power state of the display device 100. Accordingly, the PD controller 104 may sends a PD protocol message to the host computing device 110 to synchronize the power state of the host computing device 110 with the power off state. That is, the updated power state of the host computing device 110 may be a hibernation state (S4) or a soft power off state (S5).

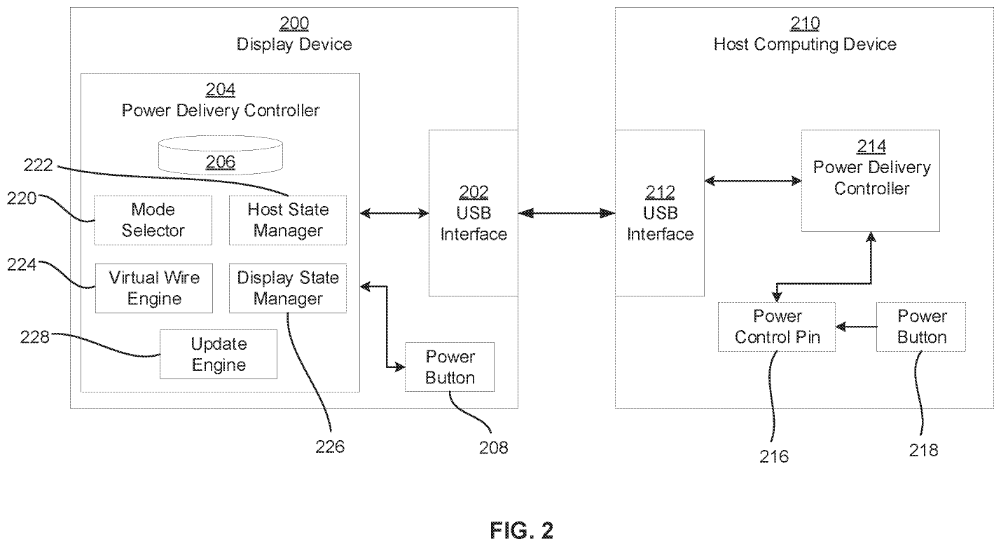

FIG. 2 depicts a block diagram of another example display device 200. The display device 200 includes a universal serial bus (USB) interface 202, a power delivery (PD) controller 204 interconnected with the USB interface 202, and a power button 208 interconnected with the PD controller 204.

The USB interface 202 is similar to the USB interface 102. In particular, the USB interface 202 is to couple to a host computing device 210 via a corresponding USB interface 212 of the host computing device 210. In particular, the USB interface 202 may be a type C USB interface to allow power delivery protocols to be employed in communications between the display device 200 and the host computing device 210. Further, the type C USB interfaces 202 may allow vendor defined messages to be communicated between the display device 200 and the host computing device 210.

The PD controller 204 is interconnected with the USB interface 202 and may include a processing device, such as a central processing unit (CPU), a microcontroller, a microprocessor, a processing core, or similar device capable of executing instructions. The PD controller 204 may also include a non-transitory machine-readable storage medium that may be electronic, magnetic, optical, or other physical storage device that stores executable instructions. The PD controller 204 also stores a host state register 206 to record a current power state of the host computing device 110.

In particular, the PD controller 204 also includes subcomponents operated by the PD controller 204 to execute instructions to implement the functionality described herein. In particular, the PD controller 204 includes a mode selector 220 to enable an alternative mode for the USB type C communications, a host state manager 222 to manage the host state register 206, a virtual wire engine 224 to communicate vendor defined messages between the display device 200 and the host computing device 210, a display state manager 226 to manage a power state of the display device 200, and an update engine 228 to update the host state register 206. The above components are said to perform various actions via execution of the instructions by the processing device of the PD controller 204.

The power button 208 is disposed on the display device 200 to receive user input, for example by pressing the button, and is interconnected with the PD controller 204. Specifically, the power button 208 is to allow the user to toggle a power state of the display device 200 between a power on state and a power off state.

The host computing device 210 may be, for example, a laptop or a notebook computer. The host computing device 210 also includes a respective power delivery controller 214 interconnected with the USB interface 212 and a power button 218 interconnected with the power delivery controller 214 via a power control pin 216.

The USB interface 212 is similar to the USB interfaces 102 and 202. In particular, the USB interfaces 212 may be a type C USB interface to allow power delivery protocols to be employed in communications between the display device 200 and the host computing device 210. Further, the type C USB interface 212 may allow vendor defined messages to be communicated between the display device 200 and the host computing device 210.

The PD controller 214 may include a processing device, such as a central processing unit (CPU), a microcontroller, a microprocessor, a processing core, or similar device capable of executing instructions. The PD controller 204 may also include a non-transitory machine-readable storage medium that may be electronic, magnetic, optical, or other physical storage device that stores executable instructions.

The power button 218 is disposed on the host computing device 210 to receive user input, for example by pressing and releasing the power button 218. The power button 218 is interconnected with the power control pin 216. In particular, when the power button 218 is pressed, the power control pin 216 is asserted, and when the power button 218 is released, the power control pin 216 is de-asserted. The power state of the host computing device 210 are then affected based on the assertion and de-assertion of the power control pin 216. The power button 218 thus allows the user to toggle between power states of the host computing device 210.

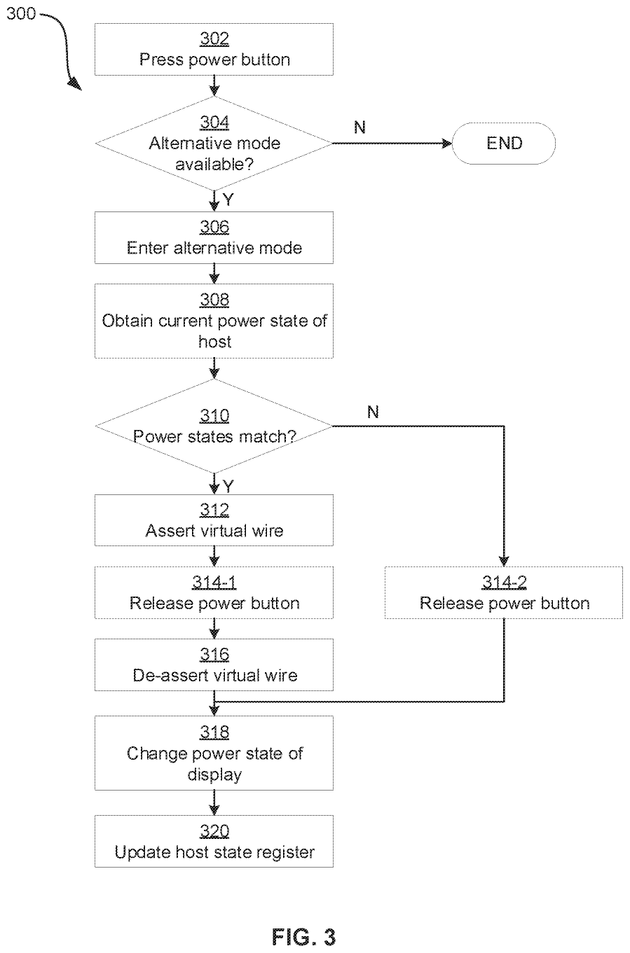

FIG. 3 depicts a flowchart of an example method 300 of synchronizing power states between a display device and a host computing device, In particular, the method 300 may be performed to synchronize power states between the display device and the host computing device when a power button of the display device is actuated. The method 300 will be described in conjunction with its performance by the display device 200, and in particular, the PD controller 204, the mode selector 220, the host state manager 222, the virtual wire engine 224, the display state manager 226, and the update engine 228. In particular, communications between the components of the display device 200 and the host computing device 210 are sent and received via the USB interfaces 202 and 212. In other examples, the method 300 may be performed by other suitable devices or systems.

The method 300 is initiated at block 302. At block 302, the PD controller 204 receives an indication that the power button 208 is pressed.

At block 304, the mode selector 220 determines whether the display device 200 and the host computing device 210 may enter an alternative mode allowing for communications using vendor defined messages. In particular, the mode selector 220 may send a PD protocol message via the USB interface 202 to initiate a discovery process by the host computing device 210, and in particular, the PD controller 214 of the host computing device 210. In response to a discovery inquiry, the mode selector 220 may communicate identifiers to allow the PD controller 214 to verify that the display device 200 can communicate via the alternative mode. If no such discovery process is initiated by the host computing device 210, the mode selector 220 determines that no alternative mode is available for communication between the host computing device 210 and the display device 200, and the method 300 ends.

If the discovery process is initiated by the host computing device 210 and is successfully verified, the method 300 proceeds to block 306. At block 306, the mode selector 220 enters the alternative mode. In particular, the mode selector 220 may enter the alternative mode in response to a command from the PD controller 214. At block 306, the mode selector 220 may also configure the PD controller 214 for the alternative mode, for example, in response to configuration messages from the PD controller 214.

At block 308, the host state manager 222 obtains the current power state of the host computing device 210. In particular, the host state manager 222 checks the host state register 206 to determine the current power state of the host computing device 210. If the host state register 206 does not include a current power state of the host computing device 210, the host state manager 222 requests, from the host computing device 210, the current power state. Accordingly, the host state manager 222 may obtain the current power state from the host computing device 210, and in particular, from the PD controller 214. If the host state register 206 includes the current power state of the host computing device 210, the host state manager 222 may simply obtain the current power state from the host state register 206.

At block 310, the host state manager 222 determines whether the current power state of the host computing device 210 corresponds to a current power state of the display device 200.

In some examples, the PD controller 204 may define corresponding states according to Table 1:

### Table 1: Corresponding Power States

TABLE 1
Corresponding Power States

| Host | Corresponding |
|---|---|
| Computing | Display |
| Device | Device |
| Power State | Power State |
| S0-Functional | Power On |
| S3-Sleep | Power On |
| S4-Hibernate | Power Off |
| S5-Soft Off | Power Off |

In particular, the user may actuate the power button 208 to toggle the power state of the display device 200. If the display device 200 and the host computing device 210 are in corresponding power states (e.g. both in power on states, or both in power off/hibernation states) when the power button 208 is pressed, then the current power state of the host computing device 210 is also to be toggled to maintain power synchronizations. If the display device 200 and the host computing device 210 are in non-corresponding power states (e.g. the display device is in a power off state, but the host computing device is in a power on state), then the power state of the display device 200 may be toggled without affecting the power state of the host computing device 210 to maintain power synchronizations. In particular, in the present example, when the host computing device 210 is in the sleep state (S3), the synchronization may be performed by default by the graphics card of the host computing device 210. For example, when the host computing device 210 enters the sleep state while the display device 200 is on, the display device 200 may also enter a power off state when the synchronization signal from the graphics card is removed. Accordingly, the sleep state of the host computing device 210 may be treated as corresponding to the power on state of the display device 200.

Accordingly, if at block 310, the host state manager 222 determines that the current power state of the host computing device 210 corresponds to the current power state of the display device 200, the method 300 proceeds to block 312. If the host state manager 222 determines that the current power state of the host computing device 210 does not correspond to the current power state of the display device 200, the method 300 proceeds to block 314-2.

At block 312, the virtual wire engine 224 asserts a virtual wire at the host computing device 210. In particular, the virtual wire engine 224 sends a vendor defined message to the PD controller 214 of the host computing device 210 to assert the virtual wire. For example, the message may include an indication to assert a virtual wire, such as a bit in the vendor defined message assigned to a predefined value (e.g. the virtual wire bit assigned a “0” indicates that the virtual wire is to be asserted). In response to receiving the message to assert the virtual wire, the PD controller 214 toggles the power control pin 216 of the host computing device 210 to an asserted state.

At blocks 314-1 and 314-2, the PD controller 204 receives an indication that the power button 208 is released.

At block 316, the virtual wire engine 224 de-asserts the virtual wire at the host computing device 210. In particular, the virtual wire engine 224 sends another vendor defined message to the PD controller 214 of the host computing device 210 to de-assert the virtual wire. For example, the message may include an indication to de-assert the virtual wire (e.g. the virtual wire bit may be assigned a “1” to indicate that the virtual wire is to be de-asserted). In response to receiving the message to de-assert the virtual wire, the PD controller 214 toggles the power control pin 216 of the host computing device 210 to a de-asserted state.

Thus, the vendor defined messages sent by the virtual wire engine 224 provide a virtual wire from the power button 208 to the power control of the host computing device 210. When the power control pin 216 is de-asserted, the host computing device 210 controls its power state to an updated power state based on the current power state and system settings (i.e. an opposing power state of the current power state). For example, if the current power state of the host computing device 210 is functional (S0), then the host computing device 210 may proceed to a hibernate (S4) or soft power off (S5) state, according to the system settings. By using the virtual wire to assert and de-assert the power control pin 216 based on actuation of the power button 208 of the display device 200, the host computing device 210 may respond as if its own power button 218 was pressed. Thus, for example, system settings, such as forcing a shut down when the power button is pressed and held for more than four seconds may be implemented, regardless of whether the signal is received at the power button 208 of the display device 200 or the power button 218 of the host computing device.

At block 318, responsive to the power button 208 being released, the display device 200, and in particular, the display state manager 226 changes the power state of the display device from its current state to an updated opposing power state (i.e. from a power on state to a power off state, or from a power off state to a power on state). In particular, since the host state manager 222 determined at block 310 that the current states of the display device 200 and the host computing device 210 were in correspondence, the updated power state of the host computing device 210 and the updated power state of the display device 200 also correspond.

At block 320, the PD controller 204, and in particular, the update engine 228, receives a message from the host computing device 210 indicating the updated power state of the host computing device 210 and updates the host state register 206 to reflect the updated power state.

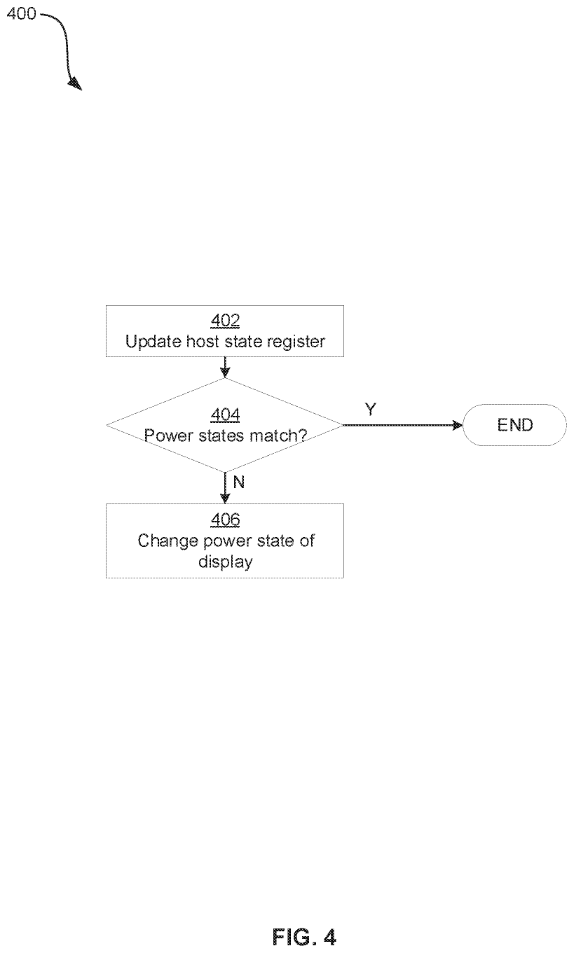

FIG. 4 depicts a flowchart of an example method 400 of synchronizing power states between a display device and a host computing device, In particular, the method 400 may be performed to synchronize power states between the display device and the host computing device when a power button of the host computing device is actuated. The method 400 is described in conjunction with its performance by the display device 200, and in particular, the PD controller 204, the mode selector 220, the host state manager 222, the virtual wire engine 224, the display state manager 226, and the update engine 228. In particular, communications between the components of the display device 200 and the host computing device 210 are sent and received via the USB interfaces 202 and 212, In other examples, the method 400 may be performed by other suitable devices or systems.

The method 400 is initiated at block 402. At block 402, the PD controller 204, receives a message from the host computing device 210 indicating an updated power state of the host computing device 210. The update engine 228 updates the host state register 206 to reflect the updated power state.

At block 404, the display state manager 226 checks the current power state of the display device 200 and compares it to the updated power state stored in the host state register 206 at block 402.

If the current power state of the display device 200 corresponds to the updated power state, the method 400 ends. Accordingly, in some implementations, after receiving the message indicating the updated power state at block 320 of the method 300, the method 400 may be performed to verify power synchronization of the display device 200 and the host computing device 210.

If the current power state of the display device 200 does not correspond to the updated power state of the host computing device 210, the method 400 proceeds to block 406. At block 406, the display state manager 226 changes the power state of the display device 200 from its current state to an updated opposing power state (e.g. from a power on state to a power off state, or from a power off state to a power on state). Thus, the updated power state of the display device 200 is synchronized to the updated power state of the host computing device 210.

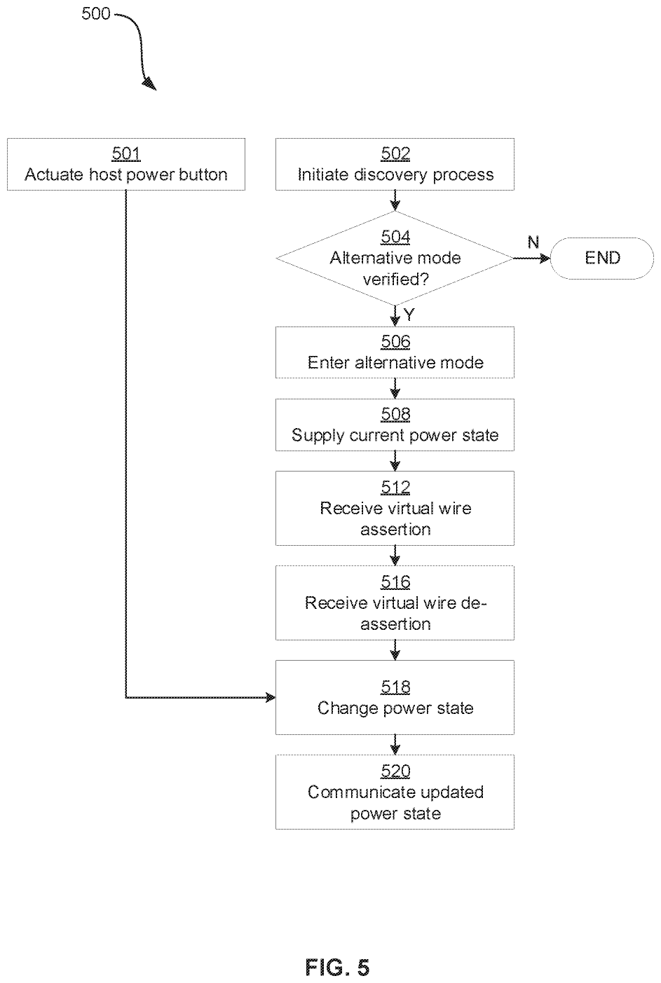

FIG. 5 depicts a flowchart of an example method 500 of synchronizing power states between a display device and a host computing device, as performed by the host computing device in conjunction with the method 300 or the method 400. In particular, the method 500 is described in conjunction with its performance by the host computing device 210. In other examples, the method 500 may be performed by other suitable devices or systems.

The method 500 may be initiated at block 501 in response to the power button 218 of the host computing device 210 being actuated. At block 501, the power button 218 is pressed and released, thereby asserting and de-asserting the power control pin 216. The method 500 then proceeds to block 518.

In other examples, the method 500 may be initiated at block 502 in response to the power button 208 of the display device 200 being actuated. At block 502, the host computing device 210, and in particular, the PD controller 214 receives a PD protocol message via the USB interface 212 to initiate a discovery process. Accordingly, the PD controller 214 may initiate the discovery process.

At block 504, the PD controller 214 verifies the availability of the alternative mode. In particular, the PD controller 214 may receive identifiers or other data from the display device 200 and may perform a verification based on the identifiers or other data to verify that the display device 200 can communicate via the alternative mode. If the verification is not successful, the PD controller 214 may determine that no alternative mode is available for communication between the host computing device 210 and the display device 200 and the method 500 ends.

If the verification is successful, the method 500 proceeds to block 506. At block 506, the PD controller 214 enters the alternative mode. Additionally, the PD controller 214 may send commands and configuration messages to the display device 200 to instruct the display device 200 to enter the alternative mode, and to configure the display device 200 for communication via the alternative mode.

At block 508, the PD controller 214 may receive an inquiry for the current power state of the host computing device 210. In response, the PD controller 214 supplies an indication of the current power state of the host computing device 210 to the display device 200. In other examples, the display device 200 may have the current power state of the host computing device 210 stored in the host state register 206, and accordingly, the method 500 may proceed directly from block 506 to block 512.

At block 512, the PD controller 214 receives a vendor defined message including an indication to assert a virtual wire. In response to receiving the indication to assert the virtual wire, the PD controller 214 toggles the power control pin 216 to an asserted state. In particular, toggling the power control pin 216 to an asserted state mimics the effect of the power button 218 of the host computing device 210 being pressed.

At block 516, the PD controller 214 receives a vendor defined message including an indication to de-assert the virtual wire. In response to receiving the indication to de-assert the virtual wire, the PD controller 214 toggles the power control pin 216 to a de-asserted state. In particular, toggling the power control pin 216 to the de-asserted state mimics the effect of the power button 218 of the host computing device 210 being released. Thus, the vendor defined messages asserting and de-asserting the virtual wire allows the host computing device 210 to react to an external source in effectively the same manner as the power button 218 itself being pressed and released (as it is, for example, at block 501).

At block 518, in response to the power control pin 216 being de-asserted, the host computing device 210 affects its power state accordingly. Generally, the host computing device 210 changes its power state from the current power state to an updated opposing power state (e.g. from a functional (S0) state to a hibernate (S4) or a soft power off (S5) state). In some examples, the host computing device 210 may force a shutdown, for example, in response to the power control pin 216 being asserted for four or more seconds.

At block 520, the host computing device 210 communicates its updated power state to the display device 200 to allow the display device 200 to synchronize to the updated power state. In particular, the display device 200 may update the host state register 206. In some examples, a basic input/output system (BIOS) or an embedded controller (EC) of the host computing device 210 may perform the communication of the updated power state to the display device 200.

As described above, a display device may be coupled to a host computing device via a universal serial bus interface capable of supporting power delivery protocols. The display device stores a host state register including a current power state of the host computing device. The display device may check the host state register prior to sending a power delivery protocol message to the host computing device. Further, the display device may synchronize its own power state to the host computing device even when the power states do not correspond. When the host computing device power state changes, the display device receives a power delivery protocol message including the updated power state and updates the host state register to allow maintenance of the power synchronizations.

The scope of the claims should not be limited by the above examples, but should be given the broadest interpretation consistent with the description as a whole.

1. A display device comprising:
a universal serial bus interface to couple to a host computing device; and
a power delivery controller interconnected with the universal serial bus interface, the power delivery controller to:
responsive to a change in state of the display device from a first power state to a second power state, obtain, from a host state register stored at the display device, a current power state of the host computing device;
when the current power state of the host computing device corresponds to the first power state, send a power delivery protocol message to the host computing device via the universal serial bus interface to synchronize a power state of the host computing device to an updated power state corresponding to the second power state; and
update the host state register to reflect the updated power state.

2. The display device of claim 1, wherein the power delivery controller is further to enter an alternative mode to communicate vendor defined messages to the host computing device.

3. The display device of claim 2, wherein the power delivery controller is to send the power delivery protocol message by:
sending a first vendor defined message to assert a virtual wire; and
sending a second vendor defined message to de-assert the virtual wire.

4. The display device of claim 1, further comprising a power button to toggle the state of the display between the first power state and the second power state.

5. The display device of claim 4, wherein the power delivery controller is further to change the state of the display device in response to actuation of the power button.

6. The display device of claim 1, wherein the universal serial bus interface comprises a type C universal serial bus interface.

7. A display device comprising:
a universal serial bus interface to couple to a host computing device;
a power delivery controller interconnected with the universal serial bus interface;
a power button interconnected with the power delivery controller;
a host state manager operated by the power delivery controller, to obtain a current power state of the host computing device;
a virtual wire engine operated by the power delivery controller, the virtual wire engine to:
assert a virtual wire at the host computing device when the power button is pressed; and
de-assert the virtual wire at he host computing device when the power button is released;
a display state manager operated by the power delivery controller, to change a power state of the display device between a first power state to a second power state; and
an update engine operated by the power delivery controller, to update a host state register to reflect an updated power state of the host computing device.

8. The display device of claim 7, further comprising a mode selector operated by the power delivery controller, to enter an alternative mode to communicate vendor defined messages to the host computing device.

9. The display device of claim 8, wherein the virtual wire engine is to assert the virtual wire and de-assert the virtual wire using the vendor defined messages.

10. The display device of claim 7, wherein the host state manager is to obtain the current power state of the host computing device from the host state register.

11. The display device of claim 7, wherein the host state manager is to obtain the current power state of the host computing device by requesting the current power state from the host computing device.

12. The display device of claim wherein the display state manager is further to:
check a current power state of the display device; and
when the current power state of the display device does not correspond with the updated power state of the host computing device, change the power state of the display device.

13. A host computing device comprising:
a universal serial bus interface to couple to a display device;
a power control pin;
a power delivery controller interconnected with the universal serial bus interface and the power control pin, the power delivery controller to:
responsive to a first message received via the universal serial bus interface, the first message including a first indication to assert a virtual wire, assert the power control pin; and
responsive to a second message received via the universal serial bus interface, the second message including a second indication to de-assert the virtual wire, de-assert the power control pin; and
communicate, via the universal serial bus interface, an updated power state of the host computing device to the display device to allow the display device to synchronize to the updated power state, wherein a power state of the host computing device is changed to the updated power state in response to de-asserting the power control pin.

14. The host computing device of claim 13, wherein the power delivery controller is further to enter an alternative mode to communicate vendor defined messages with the display device.

15. The host computing device of claim 14, wherein the first message and the second message are vendor defined messages.
